(19) United States
(12) Patent Application Publication
(10) Pub. No.: US 2009/0186186 A1
(43) Pub. Date: Jul. 23, 2009

(54) PLANK STRUCTURE

(76) Inventor: Chia-Lung Chen, Taichung Hsien (TW)

Correspondence Address: PAI PATENT & TRADEMARK LAW FIRM, 1001 FOURTH AVENUE, SUITE 3200, SEATTLE, WA, 98154, US

(21) Appl. No.: 12/018,338

(22) Filed: Jan. 23, 2008

(51) Int. Cl. B32B 3/02

(52) U.S. Cl. 428/80; 428/192

(57) ABSTRACT

A plank structure includes a base plate having an outer surface and an integrated annular frame having an inner surface matched with the outer surface of the base plate, wherein the frame is mounted with the base plate in such a way that the inner surface of the frame is coupled to the outer surface of the base plate. Thus, the plank structure of the invention has a simple manufacturing process and is suitable for manufacturing articles of an irregular shape.

### BACKGROUND OF THE INVENTION

1. Field of the Invention

The present invention relates generally to a plank structure and more specifically to a plank structure that has a simple manufacturing process.

2. Description of the Related Art

A wood plank generally has a variety of solid wood, plywood, fiberboard, etc. The plywood is made from thin sheets of veneer glued together and the fiberboard is made up of wood fibers bonded together and compressed into rigid sheets. Both the plywood and the fiberboard can be used for various purposes.

For example, when the plywood or the fiberboard is used for making dinning tables, office desks or cupboards, the plywood or the fiberboard is cut into a desired shape first, and then decorative wood trim is sticked on a cut surface of the plywood or the fiberboard, and then the plywood or the fiberboard is polished, lacquered and treated in additional follow-up processes. As a result, the cut surface of the plywood or the fiberboard is not exposed on outer surfaces of the plywood or the fiberboard such that the outer surfaces of the plywood or the fiberboard would look beautiful and attractive.

However, the manufacturing process of the aforesaid design is complicated and needs a lot of time. If the plywood or the fiberboard has an irregular shape, the wood trim can't be directly pasted up on the cut surface during the manufacturing process. Under this circumstance, a soft plastic extrusion will be substituted for the wood trim but the plastic extrusion is not easy to apply lacquer on and may fall off from the cut surface of the plywood or the fiberboard after a certain period of time.

### SUMMARY OF THE INVENTION

The present invention has been accomplished in view of the above-noted circumstances. It is one objective of the present invention to provide a plank structure, which has a simple manufacturing process.

It is another objective of the present invention to provide a plank structure which is suitable for manufacturing articles of an irregular shape.

It is still another objective of the present invention to provide a plank structure which has high structural strength.

To achieve these objectives of the present invention, the plank structure comprises a base plate having an outer surface and an integrated annular frame having an inner surface matched with the outer surface of the base plate, wherein the frame is mounted with the base plate in such a way that the inner surface of the frame is coupled to the outer surface of the base plate. According to this design, the plank structure of the invention has advantages of simple manufacturing process, being suitable for manufacturing articles of an irregular shape, beautiful appearance and high structural strength.

Further scope of applicability of the present invention will become apparent from the detailed description given hereinafter. However, it should be understood that the detailed description and specific examples given therein, while representing preferred embodiments of the invention, are for illustration only, since various changes and modifications within the spirit and scope of the invention will become apparent to those skilled in the art from this detailed description.

### BRIEF DESCRIPTION OF THE DRAWINGS

The present invention will be fully described in the detailed description given herein below and the accompanying drawings which are given by way of illustration only and thus are not limitative of the present invention, and wherein:

FIG. 1 is an exploded view of a plank structure according to a preferred embodiment of the present invention;

FIG. 2 is a top view of the plank structure according to the preferred embodiment of the present invention;

FIG. 3 is a partial sectional view of the plank structure according to the preferred embodiment of the present invention;

FIG. 4 is similar to FIG. 3 but showing an alternate form of the frame according to the preferred embodiment of the present invention;

FIG. 5 is similar to FIG. 4 but showing another alternate form of the frame according to the preferred embodiment of the present invention, and

FIG. 6 is a top view of the plank structure according to the preferred embodiment of the present invention, showing that the plank structure is made into a special shape.

### DETAILED DESCRIPTION OF THE INVENTION

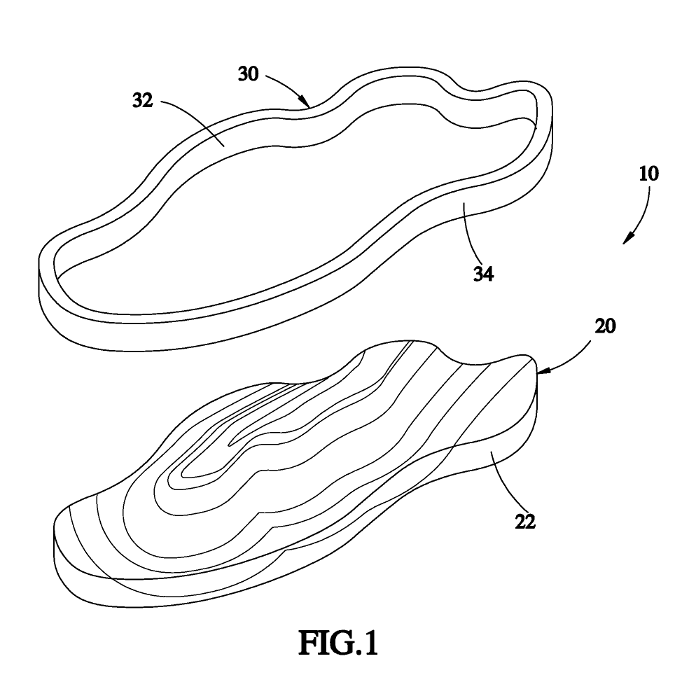

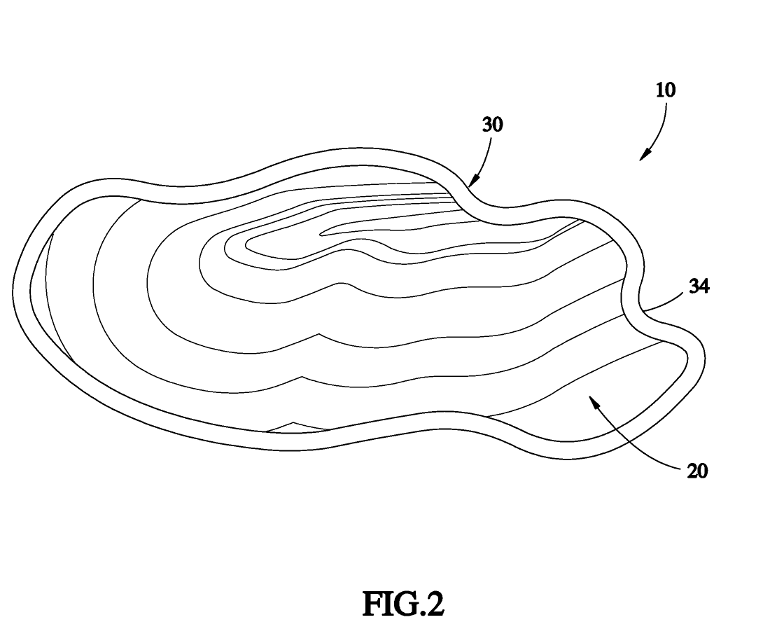

Referring to FIGS. 1 and 2, a plank structure 10 in accordance with a preferred embodiment of the present invention comprises a base plate 20 and an integrated annular frame 30.

The base plate 20, which can be plywood or fiberboard, has an irregular outer surface 22.

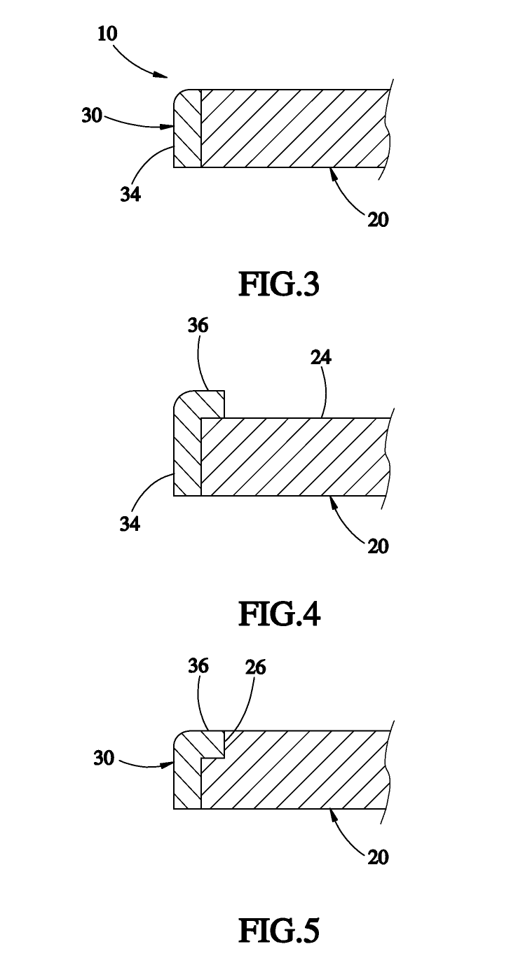

The frame 30, which can be selected from the group consisting of wood, metals and plastics, includes an inner surface 32 having the same shape as the outer surface 22 of the base plate 20 and a curved outer surface 34. As shown in FIG. 3, the frame 30 is fitted to the base plate 20 in such a way that the outer surface 22 of the base plate 20 is abutted against the inner surface 32 of the frame 30. The outer surface 22 of the base plate 20 and the inner surface 32 of the frame 30 are coupled to each other by an adhesive for fastening the frame 30 to the base plate 20.

To make the plank structure 10 of the invention, the base plate 20 and the frame 30 are respectively cut into a desired shape and lacquer is applied on outer surfaces of the base plate 20 and the frame 30. After additional follow-up processes of making the base plate 20 are finished, the frame 30 can directly be fitted to the base plate 20 because the inner surface 32 of the frame 30 matches with the outer surface 22 of the base plate 20, and then the frame 30 can be fastened to the base plate 20 by an adhesive such that the frame 30 surrounds the outer surface 22 of the base plate 20 for preventing the outer surface 22 of the base plate 20 from being exposed to the outside of the plank structure 10. In comparison to the manufacturing process of the prior art, the frame 30 and the base plate 20 have a simple process to be coupled.

As shown in FIGS. 1 and 2, if the base plate 20 has the irregular shape or is cut into a special shape according to various purposes, such as the base plate 42 for an office desk 40 shown in FIG. 6, the frame 30 can be cut into the irregular shape or the special shape and then fitted to the base plate 42. Besides, because the plywood or the fiberboard tends to warp or expand due to water absorption, the integrated frame 30 can enhance the structural strength of the base plate 20 when the frame 30 and the base plate 20 are coupled to each other by preventing the base plate 20 from warping.

By means of this design, the plank structure of the invention has advantages of simple manufacturing process, being suitable for manufacturing articles of an irregular shape, beautiful appearance and high structural strength.

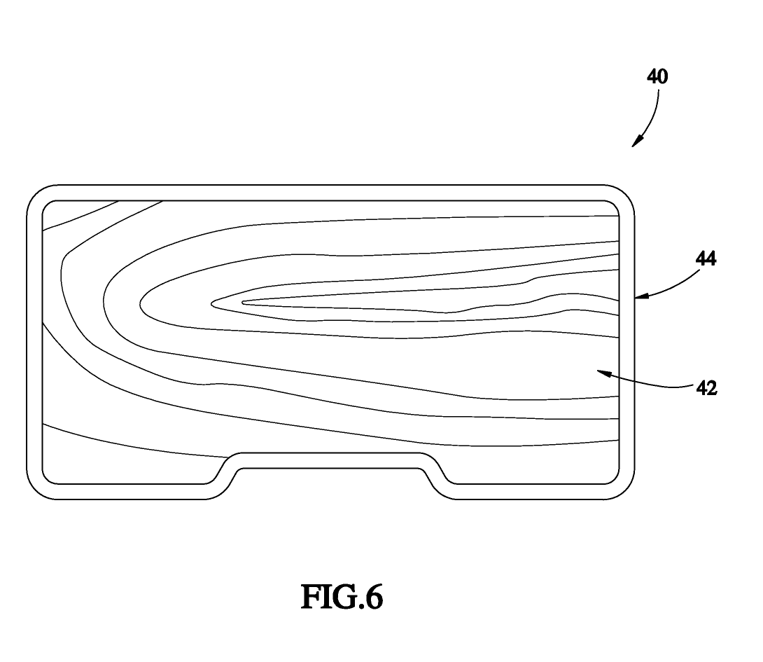

Further, the frame can be made with various kinds of design in accordance with different requirements. As shown in FIG. 4, the frame 30 includes a positioning portion 36 formed on the inner surface 32 thereof and protruded out of the inner surface 32. When the inner surface 32 of the frame 30 is coupled to the outer surface 22 of the base plate 20, the positioning portion 36 is abutted against a top surface 24 of the base plate 20 as an outer annular flange of the plank structure 10 for enhancing the structural strength of the frame 30. As shown in FIG. 5, the base plate 20 has an insertion groove 26 extending along a periphery thereof for insertion of the positioning portion 36 of the frame 30, thereby enhancing the strength between the frame 30 and the base plate 20.

The invention being thus described, it is obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plank structure comprising:
a base plate having an outer surface and a top surface; and
an integrated annular frame having an inner surface matching the outer surface of the base plate and a positioning portion on the inner surface thereof abutted against the top surface of the base plate;
wherein the integrated annular frame is mounted with the base plate in such a way that the inner surface of the integrated annular frame is coupled to the outer surface of the base plate.

2. The plank structure as claimed in claim 1, wherein the base plate includes an insertion groove extending along a periphery thereof for insertion of the positioning portion of the integrated annular frame.

3. The plank structure as claimed in claim 1, wherein the integrated annular frame has a curved outer surface thereof.

4. The plank structure as claimed in claim 1, wherein the base plate is made of plywood or fiberboard.

5. The plank structure as claimed in claim 1, wherein the integrated annular frame is made of a material selected from the group consisting of wood, metals and plastics.

6. The plank structure as claimed in claim 1, wherein both of the outer surface of the base plate and the inner surface of the integrated annular frame have an irregular shape.
